(19) United States
(12) Patent Application Publication
(10) Pub. No.: US 2021/0188669 A1
(43) Pub. Date: Jun. 24, 2021

(54) REMOVAL OF PHOSPHORUS FROM WATER

(71) Applicant: Phosphorus Free Water Solutions, LLC, Lakeland, FL (US)

(72) Inventors: Donald A. Luke, Valrico, FL (US); Brent Canham, Lakeland, FL (US); Tom Eugene Sawyer, Lithia, FL (US); Carlos Borras, Apopka, FL (US); Ruben D. Durand-Diaz, Brandon, FL (US)

(21) Appl. No.: 17/267,244

(22) PCT Filed: Aug. 20, 2019
(86) PCT No.: PCT/US19/47202

§ 371 Date: Feb. 9, 2021

Related U.S. Application Data
(60) Provisional application No. 62/730,250, filed on Sep. 12, 2018.

(51) Int. Cl. C02F 1/52; C02F 1/00; C02F 1/38; C02F 1/66; C02F 1/72; C02F 9/00

(52) U.S. Cl. CPC C02F 1/5245; C02F 1/001; C02F 1/385; C02F 2101/105; C02F 1/72; C02F 9/00; C02F 2001/007; C02F 1/66

(57) ABSTRACT

Various embodiments disclosed relate to removal of phosphorus from water using magnesium or calcium. A method of removing phosphorus from water including magnesium, calcium, or a combination thereof. The method includes forming a precipitate in the water including the phosphorus and the precipitation composition. The precipitate includes a salt that includes the phosphorus, and also includes magnesium, calcium, or a combination thereof. The method also includes removing the precipitate including the phosphorus from the water including the precipitate, to form water having a lower dissolved phosphorus concentration than the water including phosphorus that was combined with the precipitation composition. The method can include combining the water including phosphorus and a precipitation composition including a magnesium salt, a calcium salt, or a combination thereof.

### CROSS-REFERENCE TO RELATED APPLICATION

This application claims the benefit of priority to U.S. Provisional Patent Application Ser. No. 62/730,250 filed Sep. 12, 2018, the disclosure of which is incorporated herein in its entirety by reference.

### BACKGROUND

Phosphorus is a common constituent of agricultural fertilizers, manure, and organic wastes in sewage and industrial effluent. It is an essential element for plant life, but when there is too much of it in water, it can cause growth of plants and algae and deplete oxygen from the water at a rate that is greater than ecosystems can handle and can have severe ecological effects including toxic algae blooms, death of native aquatic species, and loss of biodiversity (eutrophication). Although various methods for removal of phosphorus from water are available, existing methods can be expensive, inconvenient, inefficient, lack scalability, or can be environmentally unfriendly.

### SUMMARY OF THE INVENTION

In various embodiments, the present invention provides a method of removing phosphorus from water. The method includes raising the pH of water including phosphorus to about 9.5 to about 11.6. The water includes magnesium and calcium. The method includes forming a precipitate in mixture of the water including the phosphorus and the precipitation 25 composition. The precipitate includes a phosphate salt that includes the phosphorus, and also includes magnesium, calcium, or a combination thereof. The method includes removing the precipitate including the phosphorus from the water including the precipitate, to form water having precipitate removed therefrom having a lower dissolved phosphorus concentration than the water including the phosphorus in an oxidized form. The method includes neutralizing the 30 water having precipitate removed therefrom.

In various embodiments, the present invention provides a method of removing phosphorus from water. The method includes combining water including phosphorus and a precipitation composition including a magnesium salt, a calcium salt, or a combination thereof. The method includes forming a precipitate in the water including the phosphorus and the precipitation composition. The precipitate includes a salt that includes the phosphorus, and that also includes magnesium, calcium, or a combination thereof. The method includes removing the precipitate including the phosphorus from the water including the precipitate, to form water having a lower dissolved phosphorus concentration than the water including phosphorus that was combined with the precipitation composition.

In various embodiments, the present invention provides a method of removing phosphorus from water. The method optionally includes oxidizing water including phosphorus to form water including phosphorus in an oxidized form. The method includes combining the water including the phosphorus and a precipitation composition including a magnesium salt, a calcium salt, or a combination thereof, such that a concentration of magnesium in the combination of the water including phosphorus and the precipitation composition is about 2 ppm to about 40 ppm, and such that a concentration of calcium in the combination of the water including phosphorus and the precipitation composition is about 30 ppm to about 100 ppm. The method includes raising the pH of the mixture of the water including the phosphorus and the precipitation composition to about 9.5 to about 11.6. The method includes forming a precipitate in mixture of the water including the phosphorus and the precipitation composition. The precipitate includes a magnesium phosphate salt that includes the phosphorus, and magnesium, calcium, or a combination thereof. The method includes removing the precipitate including the phosphorus from the water including the precipitate, to form water having precipitate removed therefrom having a lower dissolved phosphorus concentration than the water including the phosphorus that was combined with the precipitation composition. The method also includes neutralizing the water having precipitate removed therefrom.

In various embodiments, the present invention provides a method of removing phosphorus from water. The method includes combining water including phosphorus and a precipitation composition including a magnesium salt, a calcium salt, or a combination thereof. The method includes raising the pH of the mixture of the water including the phosphorus and the precipitation composition to about 9.5 to about 11.6. The method includes forming a precipitate in the water including the phosphorus and the precipitation composition, the precipitate including a salt that includes the phosphorus, and also includes magnesium, calcium, or a combination thereof. The method also includes filtering the precipitate including the phosphorus from the water including the precipitate through a filter, to form a filtrate including the filtered water having a lower dissolved phosphorus concentration than the water including phosphorus that was combined with the precipitation composition. The method includes backwashing the filter using a portion of the water including the phosphorus to remove the precipitate from the filter and to form a backwash liquor. The method includes combining the backwash liquor with the water including the precipitate prior to the filtering. The method also includes neutralizing the pH of the filtrate.

In various embodiments, the present invention provides an apparatus for removing phosphorus from water. The apparatus optionally includes a reactor for contacting an oxidizer and water including phosphorus to form water including phosphorus in an oxidized form. The apparatus includes a precipitation apparatus for combining the water including phosphorus with a precipitation composition including a magnesium salt, a calcium salt, or a combination thereof, to form a precipitate at a pH of about 9.5 to about 11.6, the precipitate including the phosphorus, and also including calcium, magnesium, or a combination thereof. The apparatus also includes a filtration apparatus for removing the precipitate from the water including the precipitate, to form a filtrate having a lower dissolved phosphorus concentration than the water including phosphorus that was combined with the precipitation composition.

In various embodiments, the method of phosphorus removal of the present invention has certain advantages over other methods of removal phosphorus from water. For example, in some embodiments, the method of phosphorus removal of the present invention can remove a larger amount of phosphorus, accomplish a lower concentration of phosphorus, or a combination thereof, as compared to other methods. In various embodiments, the concentration of calcium and magnesium in the water in methods of the present invention can provide more efficient and more effective removal of phosphorus as compared to other methods.

In various embodiments, the method of phosphorus removal of the present invention can be performed using lower pH levels than other methods. As the addition of base to raise the pH, and lowing the pH afterwards, can be an expensive aspect of water treatment, this feature can result in cost savings and increased efficiency.

In various embodiments, the method of phosphorus removal of the present invention can be performed with less oxidation of incoming water as compared to other methods, or with no oxidation of incoming water. In various embodiments, the method of phosphorus removal of the present invention can use a smaller footprint than other methods.

In various embodiments, the method of phosphorus removal of the present invention can include forming a filter cake during filtration of the precipitate that provides improved filtration. In various embodiments, the method can include backwashing the precipitate from the filter, to maintain an efficient and high rate of removal of precipitate from the water.

### BRIEF DESCRIPTION OF THE FIGURES

The drawings illustrate generally, by way of example, but not by way of limitation, various embodiments of the present invention.

FIG. 1 illustrates a flow diagram of a method of removing phosphorus, in accordance with various embodiments.

FIG. 2A illustrates final phosphorus concentration versus the change in concentration of calcium or magnesium, in accordance with various embodiments.

FIG. 2B illustrates final phosphorus concentration versus the change in concentration of calcium or magnesium, at a pH of 11.6, in accordance with various embodiments.

FIG. 2C illustrates the final phosphorus concentration versus the change in concentration of calcium or magnesium, at a pH of 10.8, in accordance with various embodiments.

FIG. 3 illustrates the molar ratio of dissolved calcium or magnesium concentrations to concentration of dissolved phosphorus or total phosphorus at various pH, in accordance with various embodiments.

FIG. 4 illustrates phosphorus concentration versus pH at various magnesium concentrations, in accordance with various embodiments.

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

In various embodiments, salts having a positively charged counterion can include any suitable positively charged counterion. For example, the counterion can be ammonium(NH₄⁺), or an alkali metal such as sodium (Na⁺), potassium (K⁺), or lithium (Li⁺). In some embodiments, the counterion can have a positive charge greater than +1, which can in some embodiments complex to multiple ionized groups, such as Zn²⁺, Al³⁺, or alkaline earth metals such as Ca²⁺ or Mg²⁺.

All concentrations of phosphorus, magnesium, and calcium referred to are dissolved concentrations of these materials in elemental or non-elemental forms (e.g., as a compound or ion including the material), unless otherwise indicated. All concentrations given herein are by weight unless otherwise indicated.

As used herein, “total phosphorus concentration” refers to the concentration of all forms of phosphorus, as measured by US-EPA 365.1: Determination of Phosphorus by Semi-Automated Colorimetry or equivalent, unless otherwise indicated.

As used herein, “dissolved phosphorus concentration” refers to the concentration of all forms of phosphorus passable though a 0.45 micron filter and as measured by US-EPA 365.1: Determination of Phosphorus by Semi-Automated Colorimetry or equivalent, unless otherwise indicated.

As used herein, “reactive phosphorus concentration” refers to the soluble reactive phosphorus in solution (e.g., orthophosphate) as measured by US-EPA 365.1: Determination of Phosphorus by Semi-Automated Colorimetry or equivalent unless otherwise indicated.

As used herein, “calcium concentration” refers to the concentration of Ca², ions in solution.

As used herein, “magnesium concentration” refers to the concentration of Mg ions in solution.

Method of Removing Phosphorus from Water.

Various embodiments of the present invention provide a method of removing phosphorus from water including magnesium, calcium, or a combination thereof. The method can include forming a precipitate in the water including the phosphorus and the precipitation composition. The precipitate includes a salt that includes the phosphorus, and also includes magnesium, calcium, or a combination thereof. The method also includes removing the precipitate including the phosphorus from the water including the precipitate, to form water having a lower dissolved phosphorus concentration than the water including phosphorus that was combined with the precipitation composition.

In some embodiments, the method can include combining the water including phosphorus and a precipitation composition including a magnesium salt, a calcium salt, or a combination thereof. In other embodiments, no precipitation composition is added, or none or only some of the magnesium or calcium in the water is provided by magnesium or calcium salts in a precipitation composition, while all or some of the magnesium or calcium is already in the water at the onset of the method.

The water treated by the method can be from any suitable source. For example, the water can be from a natural source of water in the environment, such as a pond, lake, river, stream, and the like. In some embodiments, the method can include taking the water from the source, returning the water to the source after removal of phosphorus, or a combination thereof. The method can be used to treat waste water, or to treat water for use as drinking water.

The phosphorus in the water including phosphorus to be treated can be in any suitable form. The phosphorus can be in the form of elemental phosphorus, inorganic phosphorus, organic phosphorus, a dissolved form of phosphorus, a solid form of phosphorus, oxidized phosphorus, or a combination thereof. The total concentration of all forms of phosphorus can be any suitable concentration, such as about 0.001 ppm to about 10,000 ppm, about 0.01 ppm to about 20 ppm, or about 0.001 ppm or less, or less than, equal to, or greater than about 0.005 ppm, 0.01, 0.05, 0.1, 0.5, 1, 2, 4, 6, 8, 10, 12, 14, 16, 18, 20, 25, 30, 40, 50, 75, 100, 125, 150, 175, 200, 250, 300, 400, 500, 750, 1,000, 1,500, 2,000, 2,500, 5,000, 7,500, or about 10,000 ppm or more. The concentration can be determined after a filtration step that removes large solids from the water, such as organic material. In general, when referring to concentrations of phosphorus, calcium, and magnesium herein, the concentration of dissolved forms of the element is referred to, as the elemental or non-elemental form (e.g., as a compound or ion including the material), unless otherwise indicated. The total concentration of dissolved or reactive phosphorus in the water to be treated by the method can be any suitable concentration, such as about 0.001 ppm to about 10,000 ppm, about 0.01 ppm to about 20 ppm, or about 0.001 ppm or less, or less than, equal to, or greater than about 0.005 ppm, 0.01, 0.015, 0.02, 0.025, 0.03, 0.035, 0.04, 0.045, 0.05, 0.06, 0.07, 0.08, 0.09, 0.1, 0.2, 0.3, 0.4, 0.5, 0.6, 0.7, 0.8, 0.9, 1, 2, 4, 6, 8, 10, 12, 14, 16, 18, 20, 25, 30, 40, 50, 75, 100, 125, 150, 175,200, 250, 300, 400, 500, 750, 1,000, 1,500, 2,000, 2,500, 5,000, 7,500, or about 10,000 ppm or more.

The treated water produced by the method, having had phosphorus removed therefrom as the precipitate described herein, can have any suitable phosphorus concentration. For example, the total concentration of dissolved or reactive phosphorus, can be less than 1 ppm, or about 0 ppm to about 1 ppm, or about 0.001 to about 0.030 ppm, or less than about 0.0001 ppm to about 0.1 ppm, or about 0 ppm, or about 0.0001 ppm or less, or less than, equal to, or greater than about 0.0005 ppm, 0.001, 0.005, 0.01, 0.015, 0.02, 0.025, 0.03, 0.035, 0.04, 0.045, 0.05, 0.06, 0.07, 0.08, 0.09, 0.1, 0.15, 0.2, 0.25, 0.3, 0.35, 0.4, 0.45, 0.5, 0.6, 0.7, 0.8, 0.9 ppm, or about 1 ppm or more.

### Oxidizing.

The method of removing phosphorus can optionally include oxidizing the water including phosphorus, to convert some or all of the phosphorus therein into oxidized forms of phosphorus that are suitable for forming salts with ions such as calcium and magnesium (e.g., as the precipitate described herein). In some embodiments, the method is free of an oxidation step, and at the onset of the method some or all of the phosphorus in the water is already in an oxidized form that is suitable for forming salts in the precipitate.

The unoxidized form of the phosphorus can be elemental phosphorus, inorganic phosphorus, organic phosphorus, a dissolved form of phosphorus, a solid form of phosphorus, or a combination thereof. The oxidized form of the phosphorus is a dissolved form of the phosphorus that is suitable for forming salts in the precipitate. The oxidized form of the phosphorus can be any compound or ion including phosphorus in an oxidation state of greater than 0, such as +1 (e.g., R₂—P(O)(O⁻)), +3 (e.g., R—P(O)(O⁻)₂ or R—P(O)(OH)(O⁻)), or +5 (e.g., P(O)(OH)₃, or P(O)(O⁻)(OH)₂, P(O)(O)₂(OH), or P(O)(O⁻)₃) or more (wherein R in this sentence can independently be any suitable organic group, such as a substituted or unsubstituted hydrocarbyl). The oxidized form of the phosphorus can include a soluble reactive form of the phosphorus, such as PO₄³⁻ or any partially oxidized material, generally in the form R₂—P(O⁻)), +3 (e.g., R—P(O)(O−)₂ or R—P(O)(OH)(O⁻)) wherein the phosphorus-oxygen bonds to other materials can hydrolyze under basic conditions. For example, a phosphorus-oxygen bond in an organic material P—O—R can hydrolyze to form H—O—R, liberating the phosphorus from the organic material. The oxidation can be sufficient to convert any suitable proportion of unoxidized phosphorus (e.g., phosphorus having an oxidation state of zero or less) to oxidized phosphorus (e.g., phosphorus having an oxidation of greater than zero), such as about 1% to about 100%, or about 50% to about 100%, or about 1% or less, or less than, equal to, or greater than about 2%, 4, 6, 8, 10, 15, 20, 25, 30, 40, 50, 60, 70, 80, 82, 84, 86, 88, 90, 92, 94, 95, 96, 97, 98, 99, 99.9, or about 99.99% or more.

In some embodiments, the oxidation can be performed if less than a certain proportion of the phosphorus in the water is in an oxidized form. For example, the oxidation can be performed if the amount of oxidized phosphorus (e.g., phosphorus having an oxidation state of greater than 0) is less than a certain proportion of the total phosphorus, such as less than about 70% to about 95%, or less than about 85% to about 90%, or less than about 70% or less, or less than about 72, 74, 76, 78, 80, 82, 84, 85, 86, 87, 88, 89, 90, 91, 92, 93, 94, or less than about 95% or more of the total phosphorus.

Oxidizing the phosphorus in the water including the phosphorus can include contacting an oxidizer and the water including phosphorus to form water including an oxidized form of the phosphorus. The oxidizer can be added in any suitable form, for example, as a solid or liquid. The oxidizer can be added an aqueous solution. The aqueous solution of the oxidizer can have any suitable concentration of the oxidizer, such that sufficient phosphorus is transformed to an oxidized form to allow a desired amount of removal of phosphorus by the method. For example, the aqueous solution of the oxidizer can have a concentration of about 0.001 ppm to about 999,999 ppm, about 50,000 ppm to about 140,000 ppm, or about 0.001 ppm or less, or less than, equal to, or greater than about 0.01 ppm, 0.1, 1, 2, 3, 4, 5, 6, 8, 10, 15, 20, 25, 30, 40, 50, 75, 100, 125, 150, 175, 200, 225, 250, 300, 350, 400, 450, 500, 600, 700, 800, 900, 1,000, 1,250, 1,500, 1,750, 2,000, 2,500, 5,000, 10,000, 15,000, 20,000, 25,000, 30,000, 50,000, 75,000, 100,000, 250,000, 500,000, 750,000, or 999,999 ppm or more.

The oxidizer used to oxidize the water including the phosphorus can be any suitable one or more oxidizers, such as including ferrate, ozone, ferric chloride (FeCl₃), potassium permanganate, potassium dichromate, potassium chlorate, potassium persulfate, sodium persulfate, perchloric acid, peracetic acid, potassium monopersulfate, hydrogen peroxide, sodium hypochlorite, potassium hypochlorite, hydroxide, sulfite, a free radical via decomposition thereof, or a combination thereof.

The oxidizer can be sodium hypochlorite (NaOCl). The sodium hypochlorite can be added to achieve any suitable concentration of the sodium hypochlorite in the water including the phosphorus, such as about 0 ppm to about 100 ppm, or about 1 ppm to about 10 ppm, or about 1 ppm to about 3 ppm, or greater than 0 ppm, or less than, equal to, or greater than about 0.001 ppm, 0.01, 0.1, 0.5, 1, 1.5, 2, 2.5, 3, 3.5, 4, 4.5, 5, 6, 8, 10, 12, 14, 16, 18, 20, 25, 30, 35, 40, 45, 50, 60, 70, 80, 90, or about 100 ppm or more.

The combination of the water and the oxidizer can be subjected to oxidation at any suitable conditions to bring about the oxidation of the phosphorus, such as at any suitable temperature and pH conditions, and for any suitable duration, such that the desired amount of phosphorus is oxidized. The oxidation can be performed under ambient conditions, at the temperature of the water source, without any temperature manipulation or control. The oxidation can be performed at a temperature of about 1° C. to about 100° C., about 10° C. to about 30° C., or about 1° C. or less, or less than, equal to, or greater than about 5° C., 10, 12, 14, 16, 18, 20, 22, 24, 26, 28, 30, 35, 40, 50, 60, 70, 80, 90, or about 100° C. or more. The oxidation can be performed under any suitable pH conditions, such as at the pH of the water source, or with no pH manipulation or control. The oxidation can be performed using a pH of about 6 to about 12, about 6 to about 11.6, about 7 to about 8.5, or about 6 or less, or less than, equal to, or greater than about 6.2, 6.4, 6.6, 6.8, 7, 7.1, 7.2, 7.3, 7.4, 7.5, 7.6, 7.7, 7.8, 7.9, 8, 8.1, 8.2, 8.3, 8.4, 8.5, 8.6, 8.8, 9, 9.2, 9.4, 9.6, 9.8, 10, 10.5, 11, 11.1, 11.2, 11.3, 11.4, 11.5, 11.6, 11.7, 11.8, 11.9, or about 12.0 or more. In some embodiments, addition of an oxidizer, such as sodium hypochlorite, can raise the pH of the water. The oxidation can be performed for any suitable amount of time, such as for a time of about 1 second to about 1 day, or about 1 minute to about 30 minutes, or about 5 minutes to about 15 minutes, or about 1 second or less, or less than, equal to, or greater than about 5 seconds, 10, 15, 20, 25, 30, 40, 50 seconds, 1 minute, 1.5, 2, 2.5, 3, 4, 5, 6, 8, 10, 12, 14, 16, 18, 20, 25, 30, 40, 50 minutes, 1 hour, 1.5, 2, 3, 4, 5, 6, 8, 10, 12, 14, 16, 18, 20, 22 hours, or 1 day or more. The oxidizing can include applying shear to the water including the phosphorus and the oxidizer.

### Precipitation Composition.

In some embodiments, the method of removing phosphorus includes adding a precipitation composition to the water including the phosphorus. The precipitation composition can be used to adjust the concentrations of various materials in the water. The precipitation composition can be used to adjust concentrations of calcium, magnesium, or a combination thereof, in the water including the phosphorus such that dissolved phosphorus precipitates from the water to accomplish a particular phosphorus concentration or degree of removal of phosphorus. In other embodiments, the method is free of adding a composition including salts such as calcium and magnesium salts to the water including the phosphorus to adjust the concentration of calcium and magnesium therein, and the phosphorus precipitates from the composition during the method without addition of a precipitation composition. The precipitation composition can include a magnesium salt, a calcium salt, or a combination thereof.

A desired concentration of calcium and magnesium can be accomplished fully via calcium or magnesium already present in the water including phosphorus, accomplished in part via calcium or magnesium already present in the water including phosphorus and in part via calcium or magnesium added via addition to the water of a calcium or magnesium salt in a precipitation composition, or accomplished fully via addition to the water of a calcium or magnesium salt in a precipitation composition. Most naturally-sourced water includes some amount of calcium and magnesium therein.

The precipitation composition can include or can be free of a magnesium salt. The magnesium salt can be chosen from a magnesium halide, magnesium hydroxide, magnesium carbonate, magnesium oxide, magnesium sulfate, magnesium nitrate, magnesium chloride, magnesium bromide, magnesium iodide, and a combination thereof. The magnesium salt in the precipitation composition can be magnesium chloride (MgCl₂).

The precipitation composition can include or be free of a calcium salt. The calcium salt can be chosen from calcium chloride, calcium bromide, calcium iodide, calcium hydroxide, calcium sulfate, calcium citrate, and a combination thereof. The calcium salt can be calcium chloride (CaCl₂).

In addition to a calcium salt, a magnesium salt, or a combination thereof, the precipitation composition can include any other suitable, such an iron salt, a sodium salt, a potassium salt, or a combination thereof.

Precipitation compositions including both magnesium salts and calcium salts can have any suitable mass or mole ratio of magnesium salts to calcium salts, such that the desired magnesium and calcium concentrations are achieved. The mass ratio of magnesium salts to calcium salts can be about 1:100 to about 100:1, or about 1:10 to about 10:1, or about 1:100 or less, or less than, equal to, or greater than about 1:50, 1:10, 1:5, 1:4, 1:3, 1:2, 1:1, 2:1, 3:1, 4:1, 5:1, 10:1, 50:1, or about 100:1 or more. The mole ratio of magnesium salts or calcium salts can be about 0.1 to about 20, or about 0.5 to about 1.5, or about 0.1 or less, or less than, equal to, or greater than about 0.2, 0.4, 0.5, 0.6, 0.7, 0.8, 0.9, 1, 1.1, 1.2, 1.3, 1.4, 1.5, 1.6, 1.8, 2, 2.5, 3, 4, 5, 6, 8, 10, 12, 14, 16, 18, or about 20 or more.

The water including the phosphorus and the precipitation composition can be contacted under any suitable conditions, such as at any suitable temperature and pH conditions. and for any suitable duration, such that a desired concentration of materials such as calcium, magnesium, or a combination thereof, is achieved. The contacting of the water including the phosphorus and the precipitation composition can be performed at ambient temperatures, without any temperature control or manipulation, or at a temperature of about 1° C. to about 100° C., about 10° C. to about 30° C., or about 1° C. or less, or less than, equal to, or greater than about 5° C., 10, 12, 14, 16, 18, 20, 22, 24, 26, 28, 30, 35, 40, 50, 60, 70, 80, 90, or about 100° C. or more. At the time of contacting of the water including the phosphorus and the precipitation composition, the water including the phosphorus can have a pH of about 6 to about 12, about 6 to about 11.6, about 7 to about 8.5, or about 6 or less, or less than, equal to, or greater than about 6.2, 6.4, 6.6, 6.8, 7, 7.1, 7.2, 7.3, 7.4, 7.5, 7.6, 7.7, 7.8, 7.9, 8, 8.1, 8.2, 8.3, 8.4, 8.5, 8.6, 8.8, 9, 9.2, 9.4, 9.6, 9.8, 10, 10.5, 11, 11.1, 11.2, 11.3, 11.4, 11.5, 11.6, 11.7, 11.8, 11.9, or about 12.0 or more. The contacting of the water including the phosphorus and the precipitation composition, prior to raising the pH, can be performed for any suitable amount of time, such as for a time of about 1 second to about 1 day, or about 1 minute to about 30 minutes, or about 5 minutes to about 15 minutes, or about 1 second or less, or less than, equal to, or greater than about 5 seconds, 10, 15, 20, 25, 30, 40, 50 seconds, 1 minute, 1.5, 2, 2.5, 3, 4, 5, 6, 8, 10, 12, 14, 16, 18, 20, 25, 30, 40, 50 minutes, 1 hour, 1.5, 2, 3, 4, 5, 6, 8, 10, 12, 14, 16, 18, 20, 22 hours, or 1 day or more. The contacting of the water including the phosphorus and the precipitation composition can include applying shear to the water including the phosphorus and the precipitation composition.

### Raising the pH.

The method of removing phosphorus can include raising the pH of water including the phosphorus. The raising of the pH can occur at any suitable time relative to the adding of the precipitation composition (if performed) and the precipitation of the phosphorus from the water. The pH of the water can be raised before the combining of the water including the phosphorus and the precipitation composition, during the combining of the water including the phosphorus and the precipitation composition, after the combining of the water including the phosphorus and the precipitation composition, before the forming of the precipitate, during the forming of the precipitate, or a combination thereof. The method can include raising the pH of the water including the phosphorus after the combining of the water including the phosphorus and the precipitation composition, if performed, and before the forming of the precipitate. In some embodiments, the raising of the pH hydrolyzes bonds to phosphorus in the water, such as bonds to organic materials, liberating the phosphorus for facile formation of precipitate.

Raising the pH can be performed in any suitable way. The pH can be raised by adding a base to the water including the phosphorus. The base can include sodium hydroxide, calcium hydroxide, magnesium hydroxide, magnesium carbonate, sodium carbonate, sodium bicarbonate, potassium hydroxide, potassium bicarbonate, potassium carbonate, sodium phosphate, disodium hydrogen phosphate, sodium aluminate, sodium borate, sodium acetate, sodium silicate, or a combination thereof. The base can be sodium hydroxide (NaOH). The base can be added as an aqueous solution of the base.

Raising the pH can raise the pH of the water including the phosphorus to about 9.5 to about 12, about 9.5 to about 11.6, about 10.3 to about 11, or about 9.5 or less, or less than, equal to, or greater than about 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, or about 12.0 or more.

### Forming a Precipitate.

The method of removing phosphorus includes forming a precipitate that includes phosphorus from the water (e.g., dissolved or reactive phosphorus). By forming and removing precipitate that includes phosphorus, the method removes phosphorus from the water.

The forming of the precipitate can be performed at any suitable conditions to bring about the precipitation of one or more salts including phosphorus, such as at any suitable temperature and pH conditions, and for any suitable duration, such that the desired amount of phosphorus is precipitated.

During the forming of the precipitate from the water, the water can have any suitable magnesium concentration. For example, the water can have a magnesium concentration of about 0.1 ppm to about 1,000 ppm, or about 2 ppm to about 40 ppm, or about 5 ppm to about 40 ppm, or about 20 ppm to about 40 ppm, or about 0.1 ppm or less, or less than, equal to, or greater than about 0.5 ppm, 1, 2, 3, 4, 5, 6, 8, 10, 12, 14, 16, 18, 20, 25, 30, 35, 40, 45, 50, 55, 60, 65, 70, 75, 80, 85, 90, 95, 100, 125, 150, 175, 200, 225, 250, 300, 400, 500, 600, 700, 800, 900 ppm, or about 1,000 or more. In some embodiments, the concentration of magnesium can be independent of the phosphorus concentration. In other embodiments, during the forming of the precipitate from the water, the water can have a magnesium concentration of about 2 ppm to about 40 ppm per 1 ppm of phosphorus in the water or to be removed from the water (e.g., as total, dissolved, or reactive phosphorus), or about 5 ppm to about 40 ppm, or about 20 ppm to about 40 ppm per 1 ppm, or about 2 ppm per 1 ppm or less, or less than, equal to, or greater than about 3 ppm, 4, 5, 6, 7, 8, 10, 12, 14, 16, 18, 20, 22, 24, 26, 28, 30, 32, 34, 36, 38 ppm per 1 ppm, or about 40 ppm per 1 ppm or more of phosphorus in the water or to be removed from the water. The source of the magnesium in the water can be magnesium that was originally in the water including phosphorus, precipitation composition including one or more magnesium salts added to the water, or a combination thereof.

During the forming of the precipitate from the water, the water can have any suitable calcium concentration. For example, the water can have a calcium concentration of about 1 ppm to about 1,000 ppm, or about 30 ppm to about 100 ppm, or about 40 ppm to about 70 ppm, or about 1 ppm or less, or less than, equal to, or greater than about 2 ppm, 3, 4, 5, 6, 8, 10, 12, 14, 16, 18, 20, 25, 30, 35, 40, 45, 50, 55, 60, 65, 70, 75, 80, 85, 90, 95, 100, 125, 150, 175, 200, 225, 250, 300, 400, 500, 600, 700, 800, 900 ppm, or about 1,000 ppm or more. In some embodiments, the concentration of magnesium can be independent of the phosphorus concentration. In other embodiments, the water can have a calcium concentration of about 30 ppm to about 100 ppm per 1 ppm of phosphorus in the water or phosphorus to be removed from the water (e.g., as total, dissolved, or reactive phosphorus), or about 40 ppm to about 70 ppm per 1 ppm of phosphorus, or about 30 ppm per 1 ppm or less, or less than, equal to, or greater than about 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, 98, 100 ppm per 1 ppm, or about 100 ppm per 1 ppm or more of phosphorus in the water or phosphorus to be removed from the water. The source of the calcium in the water can be calcium that was originally in the water including phosphorus, precipitation composition including one or more calcium salts that was added to the water, or a combination thereof.

During the forming of the precipitate in the water, the water can have any suitable relative concentrations of calcium and magnesium. In some embodiments, the water has a calcium concentration that is at least about 1.5 times greater than a concentration of magnesium in the water, or about 2 to about 10 times greater, or about 3 to about 8 times greater, or about 1.5 times greater or less, or less than, equal to, or greater than about 2 times greater, 3, 4, 5, 6, 7, 8, 9, or 10 times greater than a concentration of magnesium or more. In some embodiments, the relative concentration of calcium and magnesium is originally present in the water including the phosphorus. In some embodiments, precipitation composition is added to fully or in part provide the calcium and magnesium in the water. The precipitation composition can have a similar relative concentration of calcium and magnesium salts, or the precipitation composition can have different relative concentrations of calcium and magnesium salts with the water originally including calcium, magnesium, or a combination thereof.

The precipitate that is formed includes salts that include dissolved or reactive phosphorus from the water being treated. The precipitate can also include other salts that are free of the removed phosphorus. The phosphorus-containing salts can be phosphates or salts of any other suitable phosphorus-containing counterion. The phosphorus-containing salts can include calcium, magnesium, or a combination thereof. The calcium or magnesium in the phosphorus-containing salts can be originally present in the water including the phosphorus, from the precipitation composition (if used), or a combination thereof. For example, a phosphorus-containing salt in the precipitate including the phosphorus can include magnesium from the precipitation composition. A phosphorus-containing salt in the precipitate including the phosphorus can include calcium from the calcium salt in the precipitation composition.

A phosphorus-containing salt in the precipitate can be one or more calcium phosphates, such as monocalcium phosphate (Ca(H₂PO₄)₂), dicalcium phosphate (CaHPO₄), tricalcium phosphate (Ca₃(PO₄)₂), octacalcium phosphate (Ca₈H₂(PO₄)₆.5H₂O), amorphous calcium phosphate, dicalcium diphosphate (Ca₂P₂O₇), calcium triphosphate (Ca₅(P₃O₁₀)₂), hydroxyapatite (Ca₅(PO₄)₃(OH)), apatite (Ca₁₀(PO₄)₆(OH, F, Cl, Br)₂), tetracalcium phosphate (Ca₄(PO₄)₂₀), whitlockite (Ca₉(MgFe)PO₄)₆PO₃OH), a hydrate thereof, or a combination thereof.

A phosphorus-containing salt in the precipitate can be one or more magnesium-containing salts, such as a magnesium phosphate, a calcium phosphate, a calcium magnesium phosphate (e.g., CaMg(PO₄)₂ or CaMg₂(PO₄)₂), or a combination thereof. The magnesium containing salts can be a magnesium phosphate, such as monomagnesium phosphate (Mg(H₂PO₄)₂), dimagnesium phosphate (MgHPO₄), magnesium phosphate tribasic (Mg₃(PO₄)₂), amorphous magnesium phosphate, whitlockite (Ca₉(MgFe)PO₄)₆PO₃OH), struvite (NH₄MgPO₄.6H₂O), a hydrate thereof, or a combination thereof.

The forming of the precipitate can be performed at ambient temperatures, without any temperature control or manipulation, or at a temperature of about 1° C. to about 100° C., about 10° C. to about 30° C., or about 1° C. or less, or less than, equal to, or greater than about 5° C., 10, 12, 14, 16, 18, 20, 22, 24, 26, 28, 30, 35, 40, 50, 60, 70, 80, 90, or about 100° C. or more. The forming of the precipitate can occur during the raising of the pH, after raising of the pH, or a combination thereof. During the forming of the precipitate, the water including the phosphorus can have a pH of about 9.5 to about 12, about 9.5 to about 11.6, about 10.3 to about 11, or about 9.5 or less, or less than, equal to, or greater than about 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, or about 12.0 or more. The forming of the precipitate can be performed for any suitable amount of time prior to removal of the precipitate, such as for a time of about 1 second to about 1 day, or about 1 minute to about 30 minutes, or about 5 minutes to about 15 minutes, or about 1 second or less, or less than, equal to, or greater than about 5 seconds, 10, 15, 20, 25, 30, 40, 50 seconds, 1 minute, 1.5, 2, 2.5, 3, 4, 5, 6, 8, 10, 12, 14, 16, 18, 20, 25, 30, 40, 50 minutes, 1 hour, 1.5, 2, 3, 4, 5, 6, 8, 10, 12, 14, 16, 18, 20, 22 hours, or 1 day or more. The forming of the precipitate can include applying shear to the water including the phosphorus and the precipitation composition.

Removing the Precipitate from the Water.

The method of removing phosphorus can include removing the precipitate including the one or more phosphorus-containing salts from the water. The precipitate can be removed in any suitable way, such as by filtering, decanting, clarifying (e.g., allowing the precipitate to settle), centrifuging, or via a combination thereof.

The removing can include filtering the precipitate from the water including the precipitate through a filter, to form a filtrate including the filtered water. The filtering of the precipitate can include gravity filtration. The filtering of the precipitate can include pressurizing the water including the precipitate behind the filter, or can include forming a vacuum on the filter on the side opposite the water including the precipitate. The filter can be a rotating drum, a rotating disk, a sand filter, a traveling bridge filter, a vertical fiber cloth media filter, or a combination thereof. The filter can be a rotating filter. The filter can be a rotating disk.

The filter used to remove the precipitate can have any suitable mesh size, such as a mesh size of about 1 micron to about 100 microns, or about 5 microns to about 10 microns, or about 1 micron or less, or less than, equal to, or greater than about 2 microns, 3, 4, 5, 6, 7, 8, 9, 10, 11, 12, 13, 14, 15, 16, 18, 20, 25, 30, 40, 50, 60, 70, 80, 90, or about 100 microns or more. The filter can be any suitable filtration media, such as a glass frit, a fabric filter, a paper filter, a disk filter, a rotary filter, a drum filter, a screen, a sieve, particulate filtration media, a filter aid, or a combination thereof.

The filtering of the precipitate from the water can include forming a filter cake including the precipitate on the filter. In some embodiments, the filter cake can advantageously enhance the filtration of the water by allowing it to act like a finer filter than the filter itself, allowing a larger proportion of smaller particles to be removed than is possible using the filter alone without the filter cake. In some embodiments, Mg(OH)₂ particles in the filter cake enhance the filtration.

The filtering can include intermittently backwashing the filter to remove precipitate such as a filter cake from the filter and to form a backwash liquor that includes the removed precipitate. A portion of the water including the precipitate that is fed to the filtration can be used to backwash the filter. The backwash liquor can include about 1 vol % to about 50 vol % of the total water including the precipitate flowing to the filter, or about 10 vol % to about 30 vol %, or about 1 vol % or less, or less than, equal to, or greater than about 2 vol %, 4, 6, 8, 10, 12, 14, 16, 18, 20, 22, 24, 26, 28, 30, 35, 40, 45 vol %, or about 50 vol % or more. The backwash liquor can be optionally treated to separate solids from liquids (e.g., via settling or another suitable technique) and the liquid from the backwash can be recirculated into the process prior to the filtration or can otherwise have phosphorus removed therefrom. For example, recirculating the liquid from the backwash can include combining the backwash liquor with the water including the precipitate prior to the filtering, wherein the filtering includes filtering the precipitate from the mixture of the water including the precipitate and the backwash liquor through a filter, to form the filtrate including the filtered mixture.

The filtrate having had the precipitate removed therefrom can have any suitable dissolved or reactive phosphorus concentration, such as about 0.001 ppm to about 10,000 ppm, about 0.01 ppm to about 20 ppm, about 0.001 to about 0.030 ppm, or about 0.001 ppm or less, or less than, equal to, or greater than about 0.005 ppm, 0.01, 0.015, 0.02, 0.025, 0.03, 0.035, 0.04, 0.045, 0.05, 0.06, 0.07, 0.08, 0.09, 0.1, 0.2, 0.3, 0.4, 0.5, 0.6, 0.7, 0.8, 0.9, 1, 2, 4, 6, 8, 10, 12, 14, 16, 18, 20, 25, 30, 40, 50, 75, 100, 125, 150, 175, 200, 250, 300, 400, 500, 750, 1,000, 1,500, 2,000, 2,500, 5,000, 7,500, or about 10,000 ppm or more.

In some embodiments, the method can be free of additional phosphorus removal steps prior to completion of the method or release of the water back into the environment. In other embodiments, further phosphorus removal can be performed on some or all of the treated water, such as ion exchange, reverse osmosis, exposure to calcium- or magnesium-containing ceramics, recirculation back through the method, or a combination thereof. In some embodiments, some or all of the filtrate can be recirculated back through the process any suitable number of times, such as 1 time, 2, 3, 4, or 5 or more times, to have further phosphorus removed therefrom.

### Neutralizing.

The method of removing phosphorus from water can include neutralizing the water after removing the precipitate therefrom. For water taken from a natural source, the neutralization can be designed to return the pH of the water to near that of the natural source for returning the water to the natural environment.

The neutralization can include adding acid to the water. The acid can include a mineral acid, an organic acid, or a combination thereof. The acid can include sulfuric acid, hydrochloric acid, citric acid, or a combination thereof. The acid can be hydrochloric acid.

The neutralized water can have a pH of about 6 to about 10, or about 7 to about 9, or about 6 or less, or less than, equal to, or greater than about 6.5, 7, 7.2, 7.4, 7.6, 7.8, 8, 8.2, 8.4, 8.6, 8.8, 9, 9.5, or about 10 or more.

The method can optionally include performing further treatment steps on the neutralized water, such as filtering the water, removing nitrogen from the water, adding oxygen to the water, or a combination thereof.

Apparatus for Removing Phosphorus from Water.

Various embodiments of the present invention provide an apparatus for removing phosphorus from water. The apparatus can be any suitable apparatus that can be used to perform an embodiment of the method of phosphorus removal described herein. The apparatus can optionally include a reactor for contacting an oxidizer and water including phosphorus to form water including phosphorus in an oxidized form. Some embodiments of the apparatus do not include a reactor for performing an oxidation step. The apparatus can include a precipitation apparatus for combining the water including phosphorus with a precipitation composition including a magnesium salt, a calcium salt, or a combination thereof, to form a precipitate at a pH of about 9.5 to about 12, or about 9.5 to about 11.6. The precipitate includes the phosphorus, and also includes calcium, magnesium, or a combination thereof. The apparatus includes a filtration apparatus for removing the precipitate from the water including the precipitate, to form a filtrate having a lower phosphorus concentration than the water including phosphorus that was combined with the precipitation composition.

### EXAMPLES

Various embodiments of the present invention can be better understood by reference to the following Examples which are offered by way of illustration. The present invention is not limited to the Examples given herein. All concentrations of phosphorus, magnesium, and calcium referred to are dissolved concentrations of these materials in elemental or non-elemental forms (e.g, as a compound or ion including the material), unless otherwise indicated. All concentrations are given by weight unless otherwise indicated.

Reactive (orthophosphate) phosphorus concentration was measured following using method US-EPA 365.1: Determination of Phosphorus by Semi-Automated Colorimetry or equivalent.

Total phosphorus concentration was measured using method US-EPA 365.1: Determination of Phosphorus by Semi-Automated Colorimetry or equivalent.

Total Dissolved Phosphorus concentration was measured as listed for total phosphorus after first filtering the sample through a 0.45 micron filter.

Calcium concentration was measured as the concentration of Ca²⁺, using a modified US-EPA Method 300.1: Determination of Inorganic Anions in Drinking Water by Ion Chromatography utilizing a suppressor and column for positively charged species.

Magnesium concentration was measured as the concentration of Mg²⁺, using a modified US-EPA Method 300.1: Determination of Inorganic Anions in Drinking Water by Ion Chromatography utilizing a suppressor and column for positively charged species.

### Example 1

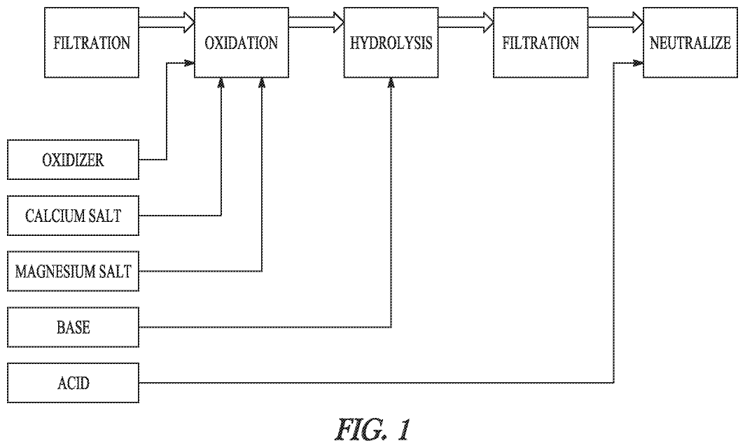

During a 2-day period, on May 17-18, 2018, a continuous pilot-scale (3 GPM) was operated to evaluate various conditions related to the removal of phosphorus by direct precipitation from natural lake water obtained from a lake in Central Florida. The equipment configuration is depicted in FIG. 1. The water was treated with 10-20 ppm bleach to liberate phosphorus contained in organic, complex or poly-phosphate form. The bleach used had a concentration of HOCl of between 6% and 12%. During this oxidation period, salts of calcium and magnesium were added to the oxidation stage where the pH is approximately 7.5 to 8. After a brief oxidation period of about 5 minutes, the water containing the phosphorus, calcium and magnesium species was then subjected to a hydrolysis stage where the addition of 50% w/w industrial NSF grade NaOH causes the pH to rise to a predetermined level and allowed to mix for approximately 10 minutes. The water, with an elevated pH, was then filtered to remove precipitated solids. The precipitated solids formed a coating on the filter cloth separating them from the water. The solid precipitate was “backwashed” off the filter cloth periodically, at intervals determined by the pressure drop across the filter cloth. The backwash water, containing substantially all of the precipitated and filtered solids, was collected, dewatered, and the solids separated from the backwash water. Backwash water, essentially free of precipitated solids, was returned to the hydrolysis tank to recover hydroxide values and any residual phosphorus. The precipitated solids were further dewatered and dried. The filtrate was then neutralized with a solution of 50% w/w citric acid to return the water to its original pH.

During this Example, the equipment was operated with only the initial addition of calcium chloride (35 ppm) and magnesium chloride (50 ppm) based on the treated water flow of 3 gpm. The filtration apparatus was an Aqua-Aerobic OptiFiber PA2-13@ Filter (5 Microns) and an OptiFiber PES-13@ (10 Microns). Repeated samples were taken at several inter-process locations, notably before and after the filtration apparatus which served as the only precipitated phosphorus removal device. Table 1 illustrates ratios of dissolved calcium or magnesium concentrations to concentration of dissolved phosphorus (DP) or total phosphorus (TP) at various pH.

TABLE I
Ratios of dissolved calcium or magnesium concentrations
to concentration of dissolved phosphorus (DP)
or total phosphorus (TP) at various pH.

| | Molar Ratios | | | |
|---|---|---|---|---|
| pH | Ca:DP | Ca:TP | Mg:DP | Mg:TP |
| 11.60 | 1174.066 | 816.8618 | 471.4058 | 327.9628027 |
| 11.48 | 1326.406 | 1008.234 | 1096.81 | 833.712487 |
| 11.14 | 2129.903 | 1338.094 | 2064.196 | 1296.814721 |
| 10.94 | 2606.492 | 890.3591 | 3409.679 | 1164.722124 |
| 10.90 | 1900.77 | 929.7247 | 2426.659 | 1186.952748 |
| 10.51 | 3012.632 | 1567.32 | 3916.349 | 2037.477414 |
| % Change | 0.610286 | 0.478816 | 0.879631 | 0.839025061 |
| Ratio | 2.565983 | 1.918708 | 8.307808 | 6.212147093 |

The data were then evaluated by comparing the change in the soluble calcium and magnesium species and plotted as a function of the resultant phosphorus concentration in molar concentration units.

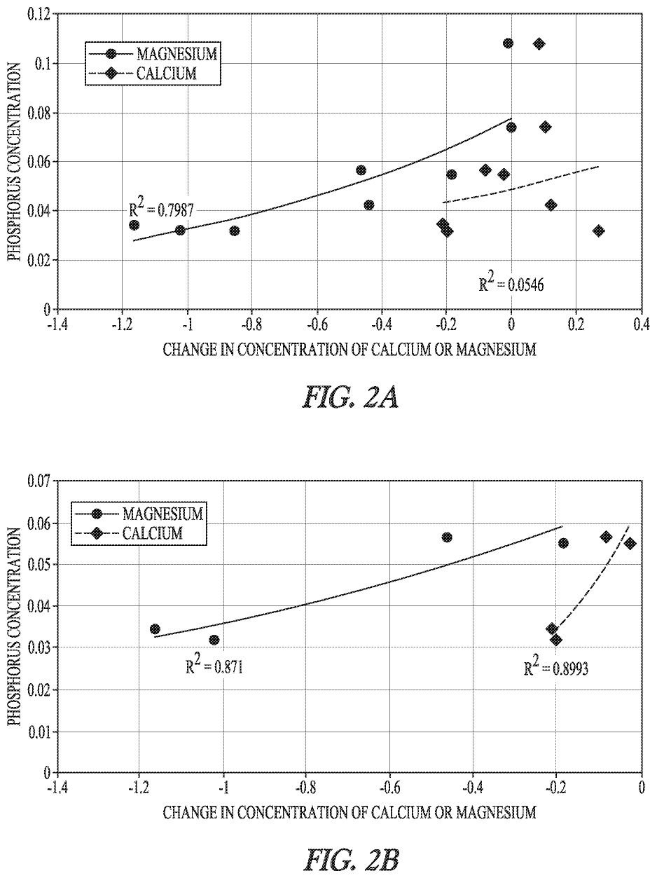

FIG. 2A illustrates the final dissolved phosphorus concentration versus the change in concentration of calcium or magnesium across the filtration device for both dates of May 17 and May 18. A negative change indicates precipitation and removal. Upon initial review, there appeared to be a reasonable and expected correlation between the magnesium and phosphorus concentrations resulting in a regression analysis equation of [P]=0.778e−^{0.8625[Mgin]-[Mgout]} generating a R² value of 0.7987, which, while not a perfect correlation, was at least a reasonable approximation of the relationship. The calcium data, however, indicated a scatter that resisted any form of regression or correlation despite the expectation that calcium should behave similarly to magnesium.

The lack of correlation for the calcium data was concerning because it did not seem to follow conventional solubility and equilibrium relationships. It was thought that the lack of correlation might be the result of inconsistent pH levels on different days so the data was split into daily summaries and the same correlation analysis attempted. FIG. 2B illustrates final dissolved phosphorus concentration versus the change in concentration of calcium or magnesium, on May 17, at a pH of 11.6. FIG. 2C illustrates the final dissolved phosphorus concentration versus the change in concentration of calcium or magnesium, on May 18, at a pH of 10.8.

FIG. 2B, at pH 11.6, illustrates both calcium and magnesium are being removed across the filter, indicating that both calcium and magnesium are reacting with phosphorus to form their respective solid species. The “slope” of the calcium regression is somewhat steeper than the magnesium regression indicating that the calcium phosphate species predominates. The smaller change in calcium concentration results in a proportionately larger change in phosphorus concentration than the same change in magnesium concentration. This is what traditional equilibrium constants and solubility relationships would indicate.

The Kₛₚ for calcium phosphate is 2.07×10³³, while for magnesium phosphate it is 1.04×10⁻²⁴; therefore, calcium phosphate is 9 orders of magnitude less soluble than the corresponding magnesium species, and one would expect the calcium phosphate species to be the primary species precipitated. Further, calcium phosphate and magnesium phosphate become less soluble as pH increases.

However, FIG. 2C indicates entirely different and unexpected relationships. It is apparent from the data that, rather than precipitate as calcium phosphate at the elevated pH as would be expected, solution calcium is increased (opposed to the expected decrease) as noted from the gain in calcium concentration across the filtration device. Further, the “slope” of the magnesium regression increases by about 25% indicating a more direct relationship between the magnesium and phosphorus at pH 10.8 than was observed at pH 11.6 in FIG. 2B. The stronger involvement of the magnesium was further supported by the resulting phosphorus concentration which remained essentially constant even though the calcium interaction was decreasing.

Even though this result is unexpected and would not be predicted by traditional equilibrium and solubility relationships, the reactions must obey basic laws of mass conservation. As such, if the solution calcium concentration is increasing, this indicates that the calcium species is dissolving at a rate faster than it is precipitating and thus, the predominate precipitating species (indicated by the consistent removal of phosphorus) in this instance must be magnesium phosphate, which is removed by the filtration device. Possibly magnesium is substituting into the calcium phosphate matrix causing the release of calcium to the solution.

### Example 2. Calcium and Magnesium Concentrations Compared to Dissolved and Total Phosphorus Concentrations at Various pH

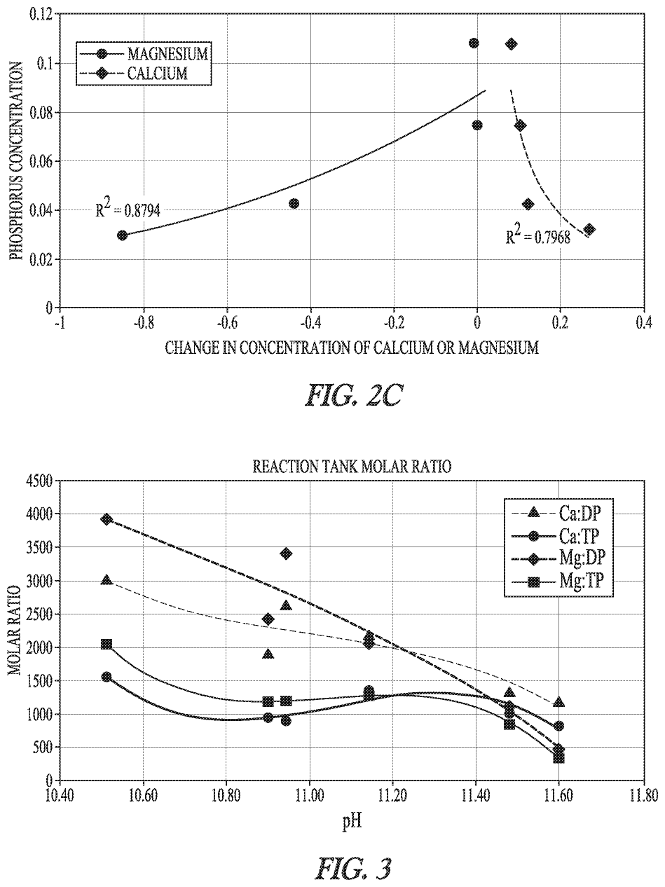

Example 1 was repeated at various pH values. Samples were taken prior to interaction with the filter, and reflect the condition of the solution after about 30 minutes of residence time at the desired pH. Table 2 illustrates the ratios of dissolved calcium or magnesium concentrations to concentration of dissolved or total phosphorus at various pH. The percent change given is the percent change in the molar ratio at the low pH value compared to the high pH value. The ratio given is the ratio of the low pH molar ratio to the high pH molar ratio, which expresses the relative reactivity of the two compounds. FIG. 3 illustrates the molar ratio of dissolved calcium or magnesium concentrations to concentration of dissolved phosphorus or total phosphorus at various pH.

TABLE 2
Ratios of dissolved calcium or magnesium concentrations
to concentration of dissolved phosphorus (DP)
or total phosphorus (TP) at various pH.

| | Molar Ratios | | | |
|---|---|---|---|---|
| pH | Ca:DP | Ca:TP | Mg:DP | Mg:TP |
| 11.60 | 1174.066 | 816.8618 | 471.4058 | 327.9628027 |
| 11.48 | 1326.406 | 1008.234 | 1096.81 | 833.712487 |
| 11.14 | 2129.903 | 1338.094 | 2064.196 | 1296.814721 |
| 10.94 | 2606.492 | 890.3591 | 3409.679 | 1164.722124 |
| 10.90 | 1900.77 | 929.7247 | 2426.659 | 1186.952748 |
| 10.51 | 3012.632 | 1567.32 | 3916.349 | 2037.477414 |
| % Change | 0.610286 | 0.478816 | 0.879631 | 0.839025061 |
| Ratio | 2.565983 | 1.918708 | 8.307808 | 6.212147093 |

Table 2 and FIG. 3 illustrate that, while there is calcium interaction occurring, the interaction between magnesium and phosphorus is significantly more prevalent. Comparing the calcium to phosphorus ratio at low (10.51) to high (11.60) pH, the calcium to phosphorus ratio decreases by a factor of 2-2.5 at the higher pH, where the same comparison for magnesium to phosphorus ratio results in a decrease by a factor of 6-8 at the higher pH, both depending on which species of phosphorus you compare (dissolved or total phosphorus). This relationship is the opposite of what traditional equilibrium chemistry would predict, where the interaction should follow roughly in proportion to the Kₛₚ values, and one would expect to see a major calcium interaction and a minor magnesium interaction and not the reverse as observed herein.

### Examples 3-10

The following Examples represent data from both laboratory-scale and continuous small-scale operations. In each case sample water from a local operating wastewater treatment plant was used. The salts were added to the water prior to the raising of pH. The pH was raised using 50% w/w industrial NSF grade NaOH. The filtration apparatus was an Aqua-Aerobic OptiFiber PA2-13@ Filter (5 Microns) and an OptiFiber PES-13® (10 Microns).

Example 3 was a baseline or control example designed to demonstrate that simply elevating the pH was not sufficient to effect suitable phosphorus removal. The results are given in Table 3.

TABLE 3
No addition of calcium or magnesium.

| Ion Dosage | None-Control |
|---|---|
| Starting Ca (ppm) | 25.0 |
| Starting Mg (ppm) | 11.3 |
| Ca After Addition | N/A |
| Mg after addition | N/A |
| pH after OH addition | 10.32 |
| Initial Dissolved P (ppm) | 0.8603 |
| Final pH | 10.32 |
| Final Ca (ppm) | 24.3 |
| Final Mg (ppm) | 11.2 |
| Final Dissolved P Removal % | 44.0 |
| Final Dissolved P (ppm) | 0.4815 |

Example 4 illustrated addition of calcium chloride to increase the calcium content, at various pH values. Tables 4-6 give the results.

TABLE 4
Addition of calcium chloride at pH 10.4.

| | Ion Dosage | | |
|---|---|---|---|
| Target pH - 10.4 | 10 ppm Ca | 20 ppm Ca | 40 ppm Ca |
| Starting Ca (ppm) | 25.4 | 25.4 | 25.4 |
| Starting Mg (ppm) | 11.4 | 11.4 | 11.4 |
| Ca After Addition (ppm) | 34.9 | 45.5 | 64.4 |
| Mg after addition (ppm) | 12.2 | 12.5 | 13.0 |
| pH after OH addition | 10.38 | 10.44 | 10.4 |
| Initial Dissolved P (ppm) | 0.94 | 0.94 | 0.94 |
| Final pH | 10.38 | 10.44 | 10.4 |
| Final Ca (ppm) | 33.6 | 43.5 | 18.3 |
| Final Mg (ppm) | 12.1 | 12.3 | 12.5 |
| Final Dissolved P Removal % | 64.5 | 85.5 | 93.9 |
| Final Dissolved P (ppm) | 0.334 | 0.136 | 0.057 |

TABLE 5
Addition of calcium chloride at pH 11.6.

| | Ion Dosage | | |
|---|---|---|---|
| Target pH - 11.6 | 10 ppm Ca | 20 ppm Ca | 40 ppm Ca |
| Starting Ca (ppm) | 25.4 | 25.4 | 25.4 |
| Starting Mg (ppm) | 11.4 | 11.4 | 11.4 |
| Ca After Addition (ppm) | 35.2 | 46.1 | 65.2 |
| Mg after addition (ppm) | 12.2 | 12.5 | 13.0 |
| pH after OH addition | 11.55 | 11.55 | 11.55 |
| Initial Dissolved P (ppm) | 0.94 | 0.94 | 0.94 |
| Final pH | 11.55 | 11.55 | 11.55 |
| Final Ca (ppm) | 32.5 | 41.4 | 27.0 |
| Final Mg (ppm) | 0.82 | 0.77 | 0.59 |
| Final Dissolved P Removal % | 95.0 | 97.8 | 97.0 |
| Final Dissolved P (ppm) | 0.047 | 0.021 | 0.028 |

TABLE 6
Addition of calcium chloride at pH 12.2.

| | Ion Dosage | | |
|---|---|---|---|
| Target pH - 12.2 | 10 ppm Ca | 20 ppm Ca | 40 ppm Ca |
| Starting Ca (ppm) | 25.4 | 25.4 | 25.4 |
| Starting Mg (ppm) | 11.4 | 11.4 | 11.4 |
| Ca After Addition (ppm) | 35.5 | 45.2 | 65.9 |
| Mg after addition (ppm) | 12.0 | 12.2 | 12.4 |
| pH after OH addition | 12.16 | 12.1 | 12.16 |
| Initial Dissolved P (ppm.) | 0.94 | 0.94 | 0.94 |
| Final pH | 12.2 | 12.19 | 12.22 |
| Final Ca (ppm) | 31.4 | 39.3 | 53.5 |
| Final Mg (ppm) | 0.29 | 0.55 | 0.53 |
| Final Dissolved P Removal % | 94.5 | 95.3 | 96.6 |
| Final Dissolved P (ppm) | 0.052 | 0.044 | 0.032 |

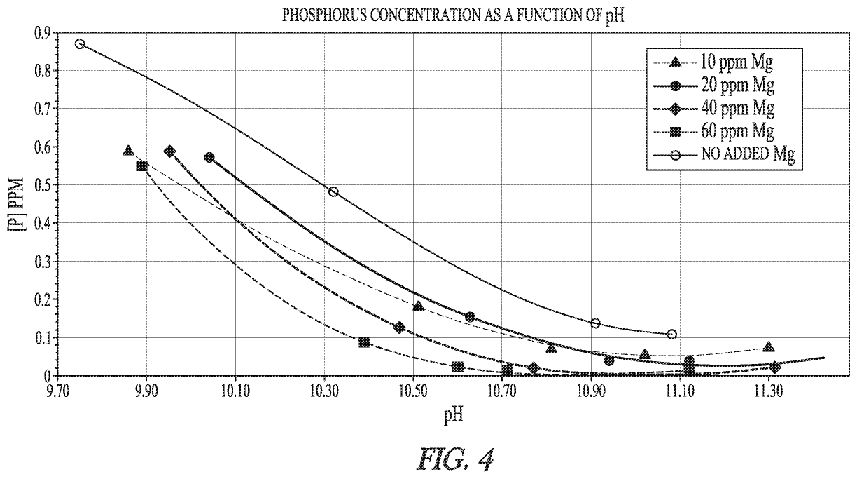

In Example 5, magnesium chloride was used to adjust the magnesium concentration at various pH levels. FIG. 4 illustrates phosphorus concentration versus pH at various magnesium concentrations.

In Example 6, magnesium chloride was evaluated at pH 10.4. The results are given in Table 7.

TABLE 7
Addition of magnesium chloride at pH 10.4.

Ion Dosage

| | 20 ppm Mg | 40 ppm Mg |
|---|---|---|
| Starting Ca (ppm) | 25.4 | 25.4 |
| Starting Mg (ppm) | 11.4 | 11.4 |
| Ca After Addition (ppm) | 25.62 | 25.82 |
| Mg after addition (ppm) | 21.43 | 50.2 |
| pH after OH addition | 10.42 | 10.43 |
| Initial Dissolved Reactive P (ppm) | 0.954 | 0.954 |
| Filtered Reactive P (ppm) | 0.949 | 0.949 |
| Final pH | 10.41 | 10.42 |
| Final Ca (ppm) | 25.1 | 25.4 |
| Final Mg (ppm) | 31.18 | 49.82 |
| Final Max Dissolved P Removal % | 43.08 | 43.4 |
| Final filtered P Removal % | 38.78 | 38.46 |
| Final Dissolved Reactive P (ppm) | 0.543 | 0.54 |
| Final filtered P (ppm) | 0.581 | 0.584 |

In Example 7, magnesium carbonate was added at various concentrations. The results are given in Table 8.

TABLE 8
Addition of magnesium carbonate at pH 10.4.

| | Ion Dosage | | |
|---|---|---|---|
| | | 20 ppm | 40 ppm |
| | | MgCl₂, | MgCl₂, |
| | 5 ppm | 20 ppm | 40 ppm |
| | MgCO₃ | NaCO₃ | NaCO₃ |
| Starting Ca (ppm) | 24.74 | 24.74 | 24.74 |
| Starting Mg (ppm) | 11.3 | 11.33 | 11.33 |
| Ca After Addition (ppm) | 24.91 | 24.93 | 25.28 |
| Mg after addition (ppm) | 16.05 | 31.1 | 51.11 |
| pH after OH addition | 10.38 | 10.4 | 10.42 |
| Initial Dissolved Reactive P (ppm) | 0.934 | 0.926 | 0.926 |
| Filtered Reactive P (ppm) | 0.946 | 0.93 | 0.93 |
| Final pH | 10.37 | 10.4 | 10.4 |
| Final Ca (ppm) | 23.86 | 24.48 | 24.89 |
| Final Mg (ppm) | 16.29 | 30.77 | 50.29 |
| Final Max Dissolved P Removal % | 60.6 | 51.51 | 48.92 |
| Final filtered P Removal % | 52.3 | 47.85 | 44.41 |
| Final Dissolved Reactive P (ppm) | 0.368 | 0.449 | 0.473 |
| Final filtered P (ppm) | 0.451 | 0.485 | 0.517 |

Example 8 demonstrates effective dissolved phosphorus removal at pH 10.3-10.4 using appropriate molar ratios of calcium chloride and magnesium chloride. The results are given in Table 9.

TABLE 9
Addition of calcium chloride and magnesium chloride.

Ion Dosage

| | 10 ppm Mg, | 20 ppm Mg, |
|---|---|---|
| | 60 ppm Ca | 40 ppm Ca |
| Starting Ca (ppm) | 25.52 | 26.1 |
| Starting Mg (ppm) | 11.86 | 11.9 |
| Ca After Addition (ppm) | 85.97 | 66.72 |
| Mg after addition (ppm) | 22.25 | 32.3 |
| pH after OH addition | 10.38 | 10.39 |
| Initial Dissolved Reactive P (ppm) | 0.93 | 0.926 |
| Filtered Reactive P (ppm) | 0.942 | 0.94 |
| Final pH | 10.31 | 10.38 |
| Final Ca (ppm) | 48.95 | 33.24 |
| Final Mg (ppm) | 21.34 | 30.9 |
| Final Max Dissolved P Removal % | 97.31 | 95.79 |
| Final filtered P Removal % | 88.75 | 83.83 |
| Final Dissolved Reactive P (ppm) | 0.025 | 0.039 |
| Final filtered P (ppm) | 0.106 | 0.152 |

In Example 9, calcium chloride and magnesium carbonate were added together. The results are given in Table 10. Effective dissolved phosphorus removal was demonstrated.

TABLE 10
Addition of calcium chloride and magnesium carbonate.

| | Ion Dosage | | |
|---|---|---|---|
| | 5 ppm | 5 ppm | 5 ppm |
| | Mg, | Mg, | Mg, |
| | 60 ppm | 60 ppm | 60 ppm |
| | Ca | Ca | Ca |
| Starting Ca (ppm) | 25.29 | 25.29 | 25.29 |
| Starting Mg (ppm) | 11.33 | 11.34 | 11.34 |
| Ca After Addition (ppm) | 83.09 | 84.14 | 84 |
| Mg after addition (ppm) | 14.18 | 13.15 | 13.75 |
| pH after OH addition | 10.4 | 10.57 | 10.8 |
| Initial Dissolved Reactive P (ppm) | 0.947 | 0.947 | 0.947 |
| Filtered Reactive P (ppm) | 0.939 | 0.939 | 0.939 |
| Final pH | 10.25 | 10.49 | 10.77 |
| Final Ca (ppm) | 24.02 | 40.22 | 38.49 |
| Final Mg (ppm) | 14.18 | 12.94 | 10.65 |
| Final Max Dissolved P Removal % | 92.82 | 95.25 | 97.57 |
| Final filtered P Removal % | 84.98 | 88.92 | 89.78 |
| Final Dissolved Reactive P (ppm) | 0.068 | 0.045 | 0.023 |
| Final filtered P (ppm) | 0.141 | 0.104 | 0.096 |

In Example 10, calcium chloride and magnesium carbonate were added together, in varying ratios. Table 11 gives the results. The example demonstrates effective removal of dissolved phosphorus and minimization of the precipitation of the added calcium and magnesium species. Additional precipitated solids can contribute significantly to the cost of waste disposal.

TABLE 11
Addition of calcium chloride and magnesium
carbonate in varying ratios.

| | Ion Dosage | | | |
|---|---|---|---|---|
| | 20 ppm | 20 ppm | 20 ppm | 20 ppm |
| | Mg, | Mg, | Mg | Mg, |
| | 10 ppm | 20 ppm | 35 ppm | 40 ppm |
| | Ca | Ca | Ca | Ca |
| Starting Ca (ppm) | 24.74 | 24.74 | 25 | 24.74 |
| Starting Mg (ppm) | 11.33 | 11.33 | 11.3 | 11.33 |
| Ca After Addition (ppm) | 34.5 | 44.79 | 59.85 | 62.85 |
| Mg after addition (ppm) | 31.24 | 31.48 | 29.88 | 30.91 |
| pH after OH addition | 10.42 | 10.4 | 10.43 | 10.44 |
| Initial Dissolved Reactive P (ppm) | 0.926 | 0.926 | 0.94 | 0.926 |
| Filtered Reactive P (ppm) | 0.93 | 0.93 | 0.94 | 0.93 |
| Final pH | 10.42 | 10.4 | 10.43 | 10.4 |
| Final Ca (ppm) | 33.22 | 43.02 | 56.48 | 8.04 |
| Final Mg (ppm) | 30.76 | 30.29 | 29.45 | 29.08 |
| Final Max Dissolved P Removal % | 77.00 | 86.18 | 95.32 | 97.95 |
| Final filtered P Removal % | 74.84 | 76.02 | | 90.32 |
| Final Dissolved Reactive P (ppm) | 0.213 | 0.128 | 0.044 | 0.019 |
| Final filtered P (ppm) | 0.245 | 0.223 | | 0.09 |

### Example 11. Variation of Initial Phosphorus Concentration

Example 10 was performed in the same manner as Examples 3-10, but phosphorus was added using potassium phosphate monobasic to achieve the initial spiked phosphorus concentration. The amount of calcium and magnesium added was held constant. Calcium chloride and magnesium chloride were added following the addition of the phosphorus spike and each addition were at the same concentration in each case. The sample pH was then adjusted to 10.4 by addition of sodium hydroxide and the sample agitated for 20 minutes in all cases. The results are shown in Table 12.

TABLE 12
Effect of spiked additions of phosphorus on removal efficiency.

| | Ion Dosage | | | |
|---|---|---|---|---|
| | 20 ppm | 20 ppm | 20 ppm | 20 ppm |
| | Mg, | Mg, | Mg, | Mg, |
| | 40 ppm | 40 ppm | 40 ppm | 40 ppm |
| | Ca | Ca | Ca | Ca |
| Starting Ca (ppm) | 25.0 | 25.0 | 25.0 | 25.0 |
| Starting Mg (ppm) | 11.6 | 11.6 | 11.6 | 11.6 |
| Ca After Addition (ppm) | 65.2 | 65.1 | 65.8 | 64.8 |
| Mg after addition (ppm) | 33.8 | 33.2 | 33.2 | 33.2 |
| pH after OH addition | 10.42 | 10.43 | 10.44 | 10.42 |
| Initial Diss. P (ppm) | 2.7683 | 4.6469 | 6.3276 | 9.0443 |
| Final pH | 10.39 | 10.38 | 10.41 | 10.39 |
| Final Ca (ppm) | 19.6 | 18.1 | 24.3 | 39.5 |
| Final Mg (ppm) | 32.0 | 30.7 | 30.8 | 30.0 |
| Final Dissolved P (ppm) | 0.0745 | 0.0835 | 0.0912 | 0.1207 |
| Removal Efficiency | 97.3% | 98.2% | 98.5% | 98.6% |

The results demonstrate that the effectiveness of removal is not compromised when phosphorus concentrations are significantly elevated.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### EXEMPLARY EMBODIMENTS

The following exemplary embodiments are provided, the numbering of which is not to be construed as designating levels of importance:

Embodiment 1 provides a method of removing phosphorus from water, the method comprising:
combining water comprising phosphorus and a precipitation composition comprising a magnesium salt, a calcium salt, or a combination thereof;
forming a precipitate in the water comprising the phosphorus and the precipitation composition, the precipitate comprising a salt that comprises
   the phosphorus, and
   magnesium, calcium, or a combination thereof; and
removing the precipitate comprising the phosphorus from the water comprising the precipitate, to form water having a lower dissolved phosphorus concentration than the water comprising phosphorus that was combined with the precipitation composition.

Embodiment 2 provides the method of Embodiment 1, wherein the phosphorus in the water comprising the phosphorus is in the form of elemental phosphorus, inorganic phosphorus, organic phosphorus, a dissolved form of phosphorus, a solid form of phosphorus, oxidized phosphorus, or a combination thereof.

Embodiment 3 provides the method of any one of Embodiments 1-2, wherein the phosphorus in the water comprising the phosphorus is at a concentration of about 0.001 ppm to about 10,000 ppm.

Embodiment 4 provides the method of any one of Embodiments 1-3, wherein the phosphorus in the water comprising the phosphorus is at a concentration of about 0.01 ppm to about 20 ppm.

Embodiment 5 provides the method of any one of Embodiments 1-4, wherein after the removing of the precipitate comprising the phosphorus from the water, the water has a dissolved concentration of phosphorus of about 0 ppm to about 1 ppm.

Embodiment 6 provides the method of any one of Embodiments 1-5, wherein after the removing of the precipitate comprising the phosphorus from the water, the water has a dissolved concentration of phosphorus of about 0.0001 ppm to 0.1 ppm.

Embodiment 7 provides the method of any one of Embodiments 1-6, wherein the pH of the water during the forming of the precipitate is about 9.5 to about 11.6.

Embodiment 8 provides the method of any one of Embodiments 1-7, wherein the pH of the water during the forming of the precipitate is about 10.3 to about 11.

Embodiment 9 provides the method of any one of Embodiments 1-8, further comprising raising the pH of the water comprising the phosphorus before the combining of the water comprising the phosphorus and the precipitation composition, during the combining of the water comprising the phosphorus and the precipitation composition, after the combining of the water comprising the phosphorus and the precipitation composition, before the forming of the precipitate, during the forming of the precipitate, or a combination thereof.

Embodiment 10 provides the method of Embodiment 9, further comprising raising the pH of the water comprising the phosphorus after the combining of the water comprising the phosphorus and the precipitation composition and before the forming of the precipitate.

Embodiment 11 provides the method of any one of Embodiments 9-10, wherein raising the pH of the water comprising the phosphorus comprises adding base to the water comprising the phosphorus.

Embodiment 12 provides the method of any one of Embodiments 9-11, wherein after the raising of the pH, the forming of the precipitate is performed for about 1 second to about 1 day.

Embodiment 13 provides the method of any one of Embodiments 9-12, wherein after the raising of the pH, the forming of the precipitate is performed for about 10 minutes to about 30 minutes.

Embodiment 14 provides the method of any one of Embodiments 9-13, wherein after the raising of the pH, the forming of the precipitate is performed at a temperature of about 1° C. to about 100° C.

Embodiment 15 provides the method of any one of Embodiments 9-14, wherein after the raising of the pH, the forming of the precipitate is performed at a temperature of about 10° C. to about 30° C.

Embodiment 16 provides the method of any one of Embodiments 11-15, wherein the base comprises sodium hydroxide, calcium hydroxide, magnesium hydroxide, magnesium carbonate, sodium carbonate, sodium bicarbonate, potassium hydroxide, potassium bicarbonate, potassium carbonate, sodium phosphate, disodium hydrogen phosphate, sodium aluminate, sodium borate, sodium acetate, sodium silicate, or a combination thereof.

Embodiment 17 provides the method of any one of Embodiments 11-16, wherein the base is sodium hydroxide (NaOH).

Embodiment 18 provides the method of any one of Embodiments 1-17, wherein at the time of contacting of the water comprising the phosphorus and the precipitation composition, the water comprising the phosphorus has a pH of about 6 to about 11.5.

Embodiment 19 provides the method of any one of Embodiments 1-18, wherein at the time of contacting of the water comprising the phosphorus and the precipitation composition, the water comprising the phosphorus has a pH of about 7 to about 8.5.

Embodiment 20 provides the method of any one of Embodiments 1-19, wherein the contacting of the water comprising the phosphorus and the precipitation composition is performed at a temperature of about 1° C. to about 100° C.

Embodiment 21 provides the method of any one of Embodiments 1-20, wherein the contacting of the water comprising the phosphorus and the precipitation composition is performed at a temperature of about 10° C. to about 30° C.

Embodiment 22 provides the method of any one of Embodiments 1-21, wherein the contacting of the water comprising the phosphorus and the precipitation composition is performed for a time of about 1 second to about 60 minutes.

Embodiment 23 provides the method of any one of Embodiments 1-22, wherein the contacting of the water comprising the phosphorus and the precipitation composition is performed for a time of about 10 minutes to about 30 minutes.

Embodiment 24 provides the method of any one of Embodiments 1-23, wherein the forming of the precipitate comprises applying shear to the water comprising the phosphorus and the precipitation composition.

Embodiment 25 provides the method of any one of Embodiments 1-24, wherein the combination of the water comprising the phosphorus and the precipitation composition has a magnesium concentration of about 0.1 ppm to about 1,000 ppm.

Embodiment 26 provides the method of any one of Embodiments 1-25, wherein the combination of the water comprising the phosphorus and the precipitation composition has a magnesium concentration of about 2 ppm to about 40 ppm.

Embodiment 27 provides the method of any one of Embodiments 1-26, wherein the precipitation composition comprises the magnesium salt.

Embodiment 28 provides the method of Embodiment 27, wherein the magnesium salt in the precipitation composition is chosen from a magnesium halide, magnesium hydroxide, magnesium carbonate, magnesium oxide, magnesium sulfate, magnesium nitrate, magnesium chloride, magnesium bromide, magnesium iodide, and a combination thereof.

Embodiment 29 provides the method of any one of Embodiments 27-28, wherein the magnesium salt in the precipitation composition is magnesium chloride (MgCl₂).

Embodiment 30 provides the method of any one of Embodiments 1-29, wherein the precipitation composition further comprises an iron salt, a sodium salt, a potassium salt, or a combination thereof.

Embodiment 31 provides the method of any one of Embodiments 27-30, wherein the salt in the precipitate comprising the phosphorus comprises magnesium from the precipitation composition.

Embodiment 32 provides the method of any one of Embodiments 1-31, wherein the precipitation composition is free of calcium salts.

Embodiment 33 provides the method of any one of Embodiments 1-32, wherein the precipitation composition comprises the calcium salt.

Embodiment 34 provides the method of Embodiment 33, wherein the salt in the precipitate comprising the phosphorus comprises calcium from the calcium salt in the precipitation composition.

Embodiment 35 provides the method of any one of Embodiments 33-34, wherein the calcium salt is chosen from calcium chloride, calcium bromide, calcium iodide, calcium hydroxide, calcium sulfate, calcium citrate, and a combination thereof.

Embodiment 36 provides the method of any one of Embodiments 33-35, wherein the calcium salt is calcium chloride (CaCl₂).

Embodiment 37 provides the method of any one of Embodiments 1-36, wherein the salt in the precipitate comprising the phosphorus comprises a calcium phosphate.

Embodiment 38 provides the method of any one of Embodiments 1-37, wherein the salt in the precipitate comprising the phosphorus comprises monocalcium phosphate (Ca(H₂PO₄)₂), dicalcium phosphate (CaHPO₄), tricalcium phosphate (Ca₃(PO₄)₂), octacalcium phosphate (Ca₈H₂(PO₄)₆.5H₂O), amorphous calcium phosphate, dicalcium diphosphate (Ca₂P₂O₇), calcium triphosphate (Ca₅(P₃O₁₀)₂), hydroxyapatite (Ca₅(PO₄)₃(OH)), apatite (Ca₁₀(PO₄)₆(OH, F, Cl, Br)₂), tetracalcium phosphate (Ca₄(PO₄)₂O), whitlockite (Ca(MgFe)PO₄)₆PO₃OH), a hydrate thereof, or a combination thereof.

Embodiment 39 provides the method of any one of Embodiments 1-38, wherein the combination of the water comprising the phosphorus and the precipitation composition has a calcium concentration of about 1 ppm to about 1,000 ppm.

Embodiment 40 provides the method of any one of Embodiments 1-39, wherein the combination of the water comprising the phosphorus and the precipitation composition has a calcium concentration of about 30 ppm to about 100 ppm.

Embodiment 41 provides the method of any one of Embodiments 1-40, wherein the combination of the water comprising the phosphorus and the precipitation composition has a calcium concentration that is at least about 1.5 times greater than a concentration of magnesium.

Embodiment 42 provides the method of any one of Embodiments 1-41, wherein the combination of the water comprising the phosphorus and the precipitation composition has a calcium concentration that is about 2 to about 10 times greater than a concentration of magnesium.

Embodiment 43 provides the method of any one of Embodiments 1-42, wherein the combination of the water comprising the phosphorus and the precipitation composition has a calcium concentration that is about 3 to about 8 times greater than a concentration of magnesium.

Embodiment 44 provides the method of any one of Embodiments 1-43, wherein the mass ratio of magnesium salts to calcium salts in the precipitation composition is about 1:100 to about 100:1.

Embodiment 45 provides the method of any one of Embodiments 1-44, wherein the molar ratio of magnesium salts to calcium salts in the precipitation composition is about 0.01 to about 1000.

Embodiment 46 provides the method of any one of Embodiments 1-45, wherein the molar ratio of magnesium salts to calcium salts in the precipitation composition is about 0.5 to about 1.5.

Embodiment 47 provides the method of any one of Embodiments 1-46, wherein the salt in the precipitate that comprises the phosphorus is a phosphate salt.

Embodiment 48 provides the method of any one of Embodiments 1-47, wherein the salt in the precipitate that comprises the phosphorus is a magnesium phosphate.

Embodiment 49 provides the method of any one of Embodiments 1-48, wherein the salt in the precipitate that comprises the phosphorus is monomagnesium phosphate (Mg(H₂PO₄)₂), dimagnesium phosphate (MgHPO₄), magnesium phosphate tribasic (Mg₃(PO₄)₂), amorphous magnesium phosphate, whitlockite (Ca₉(MgFe)PO₄)₆PO₃OH), struvite (NH₄MgPO₄.6H₂O), a hydrate thereof, or a combination thereof.

Embodiment 50 provides the method of any one of Embodiments 1-49, wherein the salt in the precipitate that comprises the phosphorus is a magnesium phosphate, a calcium phosphate, a calcium magnesium phosphate, or a combination thereof.

Embodiment 51 provides the method of any one of Embodiments 1-50, wherein the method is free of a step of oxidizing phosphorus.

Embodiment 52 provides the method of any one of Embodiments 1-51, further comprising oxidizing the phosphorus in the water comprising the phosphorus prior to forming the precipitate.

Embodiment 53 provides the method of Embodiment 52, wherein the salt in the precipitate comprising the phosphorus comprises an oxidized form of the phosphorus.

Embodiment 54 provides the method of any one of Embodiments 52-53, wherein oxidizing the phosphorus in the water comprising the phosphorus comprises contacting an oxidizer and the water comprising phosphorus to form water comprising an oxidized form of the phosphorus.

Embodiment 55 provides the method of any one of Embodiments 52-54, wherein an aqueous solution of the oxidizer is added to the water comprising phosphorus.

Embodiment 56 provides the method of any one of Embodiments 55-55, wherein the aqueous solution of the oxidizer has a concentration of the oxidizer of about 0.001 ppm to about 999,999 ppm.

Embodiment 57 provides the method of any one of Embodiments 55-56, wherein the aqueous solution of the oxidizer has a concentration of the oxidizer of about 50,000 ppm to about 140,000 ppm.

Embodiment 58 provides the method of any one of Embodiments 54-57, wherein the oxidizer comprises ferrate, ozone, ferric chloride (FeCl₃), potassium permanganate, potassium dichromate, potassium chlorate, potassium persulfate, sodium persulfate, perchloric acid, peracetic acid, potassium monopersulfate, hydrogen peroxide, sodium hypochlorite, potassium hypochlorite, hydroxide, sulfite, a free radical via decomposition thereof, or a combination thereof.

Embodiment 59 provides the method of any one of Embodiments 54-58, wherein the oxidizer converts substantially all dissolved phosphorus in the water comprising the phosphorus into oxidized forms of phosphorus.

Embodiment 60 provides the method of any one of Embodiments 54-59, wherein the oxidizer is sodium hypochlorite (NaOCl).

Embodiment 61 provides the method of Embodiment 60, wherein the sodium hypochlorite is added such that the concentration of the sodium hypochlorite in the water comprising the phosphorus is about 0 ppm to about 100 ppm.

Embodiment 62 provides the method of any one of Embodiments 60-61, wherein the sodium hypochlorite is added such that the concentration of the sodium hypochlorite in the water comprising the phosphorus is about 1 ppm to about 10 ppm.

Embodiment 63 provides the method of any one of Embodiments 52-62, wherein the oxidation of the phosphorus in the water comprising the phosphorus is performed at a temperature of about 1° C. to about 100° C.

Embodiment 64 provides the method of any one of Embodiments 52-63, wherein the oxidation of the phosphorus in the water comprising the phosphorus is performed at a temperature of about 10° C. to about 30° C.

Embodiment 65 provides the method of any one of Embodiments 52-64, wherein the oxidation of the phosphorus in the water comprising the phosphorus is performed at a pH of about 6 to about 11.5.

Embodiment 66 provides the method of any one of Embodiments 52-65, wherein the oxidation of the phosphorus in the water comprising the phosphorus is performed at a pH of about 7 to about 8.5.

Embodiment 67 provides the method of any one of Embodiments 52-66, wherein the oxidation is performed for a time of about 1 second to about 1 day.

Embodiment 68 provides the method of any one of Embodiments 52-67, wherein the oxidation is performed for a time of about 1 minute to about 30 minutes.

Embodiment 69 provides the method of any one of Embodiments 52-68, wherein the oxidizing comprises applying shear to the water comprising the phosphorus and the oxidizer.

Embodiment 70 provides the method of any one of Embodiments 1-69, wherein the removing comprises filtering, decanting, clarifying, centrifuging, or a combination thereof.

Embodiment 71 provides the method of any one of Embodiments 1-70, wherein the removing comprises filtering the precipitate from the water comprising the precipitate through a filter, to form a filtrate comprising the filtered water.

Embodiment 72 provides the method of Embodiment 71, wherein the filtering of the precipitate comprises gravity filtration.

Embodiment 73 provides the method of any one of Embodiments 71-72, wherein the filtering of the precipitate comprises pressurizing the water comprising the precipitate behind the filter.

Embodiment 74 provides the method of any one of Embodiments 71-73, wherein the filtering of the precipitate comprises forming a vacuum on the filter on the side opposite the water comprising the precipitate.

Embodiment 75 provides the method of any one of Embodiments 71-74, wherein the filter has a mesh size of about 1 micron to about 100 microns.

Embodiment 76 provides the method of any one of Embodiments 71-75, wherein the filter has a mesh size of about 5 microns to about 10 microns.

Embodiment 77 provides the method of any one of Embodiments 71-76, wherein the filter comprises a glass frit, a fabric filter, a paper filter, a disk filter, a rotary filter, a drum filter, a screen, a sieve, particulate filtration media, a filter aid, or a combination thereof.

Embodiment 78 provides the method of any one of Embodiments 71-77, wherein the filtering comprises forming a filter cake on the filter, the filter cake comprising the precipitate.

Embodiment 79 provides the method of Embodiment 78, wherein the filter cake enhances filtration of the precipitate from the water comprising the precipitate.

Embodiment 80 provides the method of any one of Embodiments 78-79, wherein Mg(OH)₂ particles in the filter cake enhance filtration of the precipitate from the water comprising the filter cake.

Embodiment 81 provides the method of any one of Embodiments 71-80, wherein the filtration comprises backwashing the filter to remove precipitate from the filter and to form a backwash liquor that comprises the removed precipitate.

Embodiment 82 provides the method of Embodiment 81, wherein the filter is a rotating filter.

Embodiment 83 provides the method of any one of Embodiments 81-82, wherein the filter is a rotating disk.

Embodiment 84 provides the method of any one of Embodiments 81-83, wherein a portion of the water comprising the precipitate is used to backwash the filter.

Embodiment 85 provides the method of any one of Embodiments 81-84, wherein the backwash liquor comprises about 1 vol % to about 50 vol % of the total water comprising the precipitate flowing to the filter.

Embodiment 86 provides the method of any one of Embodiments 81-85, wherein the backwash liquor comprises about 10 vol % to about 30 vol % of the total water comprising the precipitate flowing to the filter.

Embodiment 87 provides the method of any one of Embodiments 81-86, comprising settling the precipitate out of the backwash liquor.

Embodiment 88 provides the method of any one of Embodiments 81-87, comprising removing phosphorus from the backwash liquor.

Embodiment 89 provides the method of Embodiment 88, wherein removing phosphorus from the backwash liquor comprises circulating the backwash liquor back into the method prior to the filtering.

Embodiment 90 provides the method of any one of Embodiments 88-89, wherein removing phosphorus from the backwash liquor comprises combining the backwash liquor with the water comprising the precipitate prior to the filtering, wherein the filtering comprises filtering the precipitate from the mixture of the water comprising the precipitate and the backwash liquor through a filter, to form the filtrate comprising the filtered mixture.

Embodiment 91 provides the method of any one of Embodiments 71-90, wherein the filtrate has a dissolved phosphorus concentration of 0.001 ppm to about 1 ppm.

Embodiment 92 provides the method of any one of Embodiments 71-91, wherein the filtrate has a dissolved phosphorus concentration of 0.001 ppm to about 0.030 ppm.

Embodiment 93 provides the method of any one of Embodiments 71-92, wherein the method is free of additional steps of removing phosphorus from the filtrate before releasing the water to the environment.

Embodiment 94 provides the method of any one of Embodiments 71-93, comprising further removing phosphorus from the filtrate before releasing the water to the environment.

Embodiment 95 provides the method of Embodiment 94, comprising subjecting the filtrate to the method as the water comprising the phosphorus.

Embodiment 96 provides the method of any one of Embodiments 1-95, further comprising neutralizing the water after removing the precipitate therefrom.

Embodiment 97 provides the method of any one of Embodiments 1-96, wherein the neutralizing comprises adding acid to the water.

Embodiment 98 provides the method of any one of Embodiments 1-97, wherein the acid comprises a mineral acid, an organic acid, or a combination thereof.

Embodiment 99 provides the method of any one of Embodiments 1-98, wherein the acid comprises sulfuric acid, hydrochloric acid, citric acid, or a combination thereof.

Embodiment 100 provides the method of any one of Embodiments 1-99, wherein the acid comprises hydrochloric acid.

Embodiment 101 provides the method of any one of Embodiments 96-100, wherein the neutralized water has a pH of about 6 to about 10.

Embodiment 102 provides the method of any one of Embodiments 96-101, wherein the neutralized water has a pH of about 7 to about 9.

Embodiment 103 provides the method of any one of Embodiments 96-102, further comprising filtering the neutralized water prior to releasing to the environment.

Embodiment 104 provides the method of any one of Embodiments 1-103, further comprising removing nitrogen from the water prior to releasing the water to the environment.

Embodiment 105 provides the method of any one of Embodiments 1-104, further comprising filtering the water comprising the phosphorus prior to the combining of the phosphorus and the precipitate composition.

Embodiment 106 provides a method of removing phosphorus from water, the method comprising:
optionally oxidizing water comprising phosphorus to form water comprising phosphorus in an oxidized form;
combining the water comprising the phosphorus and a precipitation composition comprising a magnesium salt, a calcium salt, or a combination thereof, such that a concentration of magnesium in the combination of the water comprising phosphorus and the precipitation composition is about 2 ppm to about 40 ppm, and such that a concentration of calcium in the combination of the water comprising phosphorus and the precipitation composition is about 30 ppm to about 100 ppm;
raising the pH of the mixture of the water comprising the phosphorus and the precipitation composition to about 9.5 to about 11.6;
forming a precipitate in mixture of the water comprising the phosphorus and the precipitation composition, the precipitate comprising a magnesium phosphate salt that comprises
   the phosphorus, and
   magnesium, calcium, or a combination thereof;
removing the precipitate comprising the phosphorus from the water comprising the precipitate, to form water having precipitate removed therefrom having a lower dissolved phosphorus concentration than the water comprising the phosphorus that was combined with the precipitation composition; and
neutralizing the water having precipitate removed therefrom.

Embodiment 107 provides a method of removing phosphorus from water, the method comprising:
raising the pH of water comprising phosphorus to about 9.5 to about 11.6, wherein the water comprises magnesium and calcium;
forming a precipitate in mixture of the water comprising the phosphorus and the precipitation composition, the precipitate comprising a phosphate salt that comprises
   the phosphorus, and
   magnesium, calcium, or a combination thereof:
removing the precipitate comprising the phosphorus from the water comprising the precipitate, to form water having precipitate removed therefrom having a lower dissolved phosphorus concentration than the water comprising the phosphorus in an oxidized form; and
neutralizing the water having precipitate removed therefrom.

Embodiment 108 provides the method of Embodiment 107, wherein the amount of phosphorus to be removed from the water is approximately equal to the total amount of dissolved phosphorus in the water.

Embodiment 109 provides the method of any one of Embodiments 107-108, wherein the water has a magnesium concentration of about 0.1 ppm to about 1,000 ppm.

Embodiment 110 provides the method of any one of Embodiments 107-109, wherein the water has a magnesium concentration of about 2 ppm to about 40 ppm.

Embodiment 111 provides the method of any one of Embodiments 107-110, wherein the water has a magnesium concentration of about 2 ppm to about 40 ppm per 1 ppm phosphorus to be removed from the water.

Embodiment 112 provides the method of any one of Embodiments 107-111, wherein the water has a calcium concentration of about 1 ppm to about 1,000 ppm.

Embodiment 113 provides the method of any one of Embodiments 107-112, wherein the water has a calcium concentration of about 30 ppm to about 100 ppm.

Embodiment 114 provides the method of any one of Embodiments 107-113, wherein the water has a calcium concentration of about 40 ppm to about 70 ppm per 1 ppm phosphorus to be removed from the water.

Embodiment 115 provides the method of any one of Embodiments 107-114, wherein the water has a calcium concentration that is at least about 1.5 times greater than a concentration of magnesium in the water.

Embodiment 116 provides the method of any one of Embodiments 107-115, wherein the water has a calcium concentration that is about 2 to about 10 times greater than a concentration of magnesium in the water.

Embodiment 117 provides the method of any one of Embodiments 107-116, wherein the water has a calcium concentration that is about 3 to about 8 times greater than a concentration of magnesium in the water.

Embodiment 118 provides the method of any one of Embodiments 107-117, further comprising oxidizing water comprising phosphorus to form the water that is subjected to the raising of pH.

Embodiment 119 provides the method of any one of Embodiments 107-118, further comprising adding a precipitation composition comprising a calcium salt, a magnesium salt, or a combination thereof, to the water comprising phosphorus, to form the water that is subjected to the raising of pH.

Embodiment 120 provides a method of removing phosphorus from water, the method comprising:
combining water comprising phosphorus and a precipitation composition comprising a magnesium salt, a calcium salt, or a combination thereof;
raising the pH of the mixture of the water comprising the phosphorus and the precipitation composition to about 9.5 to about 11.6;
forming a precipitate in the water comprising the phosphorus and the precipitation composition, the precipitate comprising a salt that comprises
   the phosphorus, and
   magnesium, calcium, or a combination thereof; and
filtering the precipitate comprising the phosphorus from the water comprising the precipitate through a filter, to form a filtrate comprising the filtered water having a lower dissolved phosphorus concentration than the water comprising phosphorus that was combined with the precipitation composition;
backwashing the filter using a portion of the water comprising the phosphorus to remove the precipitate from the filter and to form a backwash liquor;
combining the backwash liquor with the water comprising the precipitate prior to the filtering; and
neutralizing the pH of the filtrate.

Embodiment 121 provides an apparatus for removing phosphorus from water, the apparatus comprising:
an optional reactor for contacting an oxidizer and water comprising phosphorus to form water comprising phosphorus in an oxidized form;
a precipitation apparatus for combining the water comprising phosphorus with a precipitation composition comprising a magnesium salt, a calcium salt, or a combination thereof, to form a precipitate at a pH of about 9.5 to about 11.6, the precipitate comprising
   the phosphorus, and
   calcium, magnesium, or a combination thereof;
a filtration apparatus for removing the precipitate from the water comprising the precipitate, to form a filtrate having a lower dissolved phosphorus concentration than the water comprising phosphorus that was combined with the precipitation composition.

Embodiment 122 provides the method or apparatus of any one or any combination of Embodiments 1-121 optionally configured such that all elements or options recited are available to use or select from.

What is claimed is:

1. A method of removing phosphorus from water, the method comprising:
combining water comprising phosphorus and a precipitation composition comprising a magnesium salt, a calcium salt, or a combination thereof;
forming a precipitate in the water comprising the phosphorus and the precipitation composition, the precipitate comprising a salt that comprises
the phosphorus, and
magnesium, calcium, or a combination thereof; and
removing the precipitate comprising the phosphorus from the water comprising the precipitate, to form water having a lower dissolved phosphorus concentration than the water comprising phosphorus that was combined with the precipitation composition.

2. The method of claim 1, wherein after the removing of the precipitate comprising the phosphorus from the water, the water has a concentration of dissolved phosphorus of about 0 ppm to about 1 ppm.

3. The method of claim 1, wherein after the removing of the precipitate comprising the phosphorus from the water, the water has a concentration of dissolved phosphorus of about 0.0001 ppm to 0.1 ppm.

4. The method of claim 1, wherein the pH of the water during the forming of the precipitate is about 9.5 to about 11.6.

5. The method of claim 1, wherein the precipitation composition comprises the magnesium salt and the magnesium salt in the precipitation composition is chosen from a magnesium halide, magnesium hydroxide, magnesium carbonate, magnesium oxide, magnesium sulfate, magnesium nitrate, magnesium chloride, magnesium bromide, magnesium iodide, and a combination thereof.

6. The method of claim 1, wherein the precipitation composition further comprises an iron salt, a sodium salt, a potassium salt, or a combination thereof.

7. The method of claim 1, wherein the salt in the precipitate comprising the phosphorus comprises calcium from the calcium salt in the precipitation composition, wherein the calcium salt is chosen from calcium chloride, calcium bromide, calcium iodide, calcium hydroxide, calcium sulfate, calcium citrate, and a combination thereof.

8. The method of claim 1, wherein the salt in the precipitate comprising the phosphorus comprises a calcium phosphate.

9. The method of claim 1, wherein the combination of the water comprising the phosphorus and the precipitation composition has a calcium concentration that is at least about 1.5 times greater than a concentration of magnesium.

10. The method of claim 1, wherein the combination of the water comprising the phosphorus and the precipitation composition has a calcium concentration that is about 2 to about 10 times greater than a concentration of magnesium.

11. The method of claim 1, wherein the salt in the precipitate that comprises the phosphorus is a phosphate salt.

12. The method of claim 1, wherein the salt in the precipitate that comprises the phosphorus is a magnesium phosphate, a calcium phosphate, a calcium magnesium phosphate, or a combination thereof.

13. The method of claim 1, further comprising oxidizing the phosphorus in the water comprising the phosphorus prior to forming the precipitate, wherein oxidizing the phosphorus in the water comprising the phosphorus comprises contacting an oxidizer and the water comprising phosphorus to form water comprising an oxidized form of the phosphorus.

14. The method of claim 1, wherein the removing comprises filtering, decanting, clarifying, centrifuging, or a combination thereof.

15. The method of claim 1, wherein the removing comprises filtering the precipitate from the water comprising the precipitate through a filter, to form a filtrate comprising the filtered water.

16. The method of claim 15, wherein the filtration comprises backwashing the filter to remove precipitate from the filter and to form a backwash liquor that comprises the removed precipitate.

17. The method of claim 16, wherein a portion of the water comprising the precipitate is used to backwash the filter.

18. A method of removing phosphorus from water, the method comprising:
optionally oxidizing water comprising phosphorus to form water comprising phosphorus in an oxidized form;
combining the water comprising the phosphorus and a precipitation composition comprising a magnesium salt, a calcium salt, or a combination thereof, such that a concentration of magnesium in the combination of the water comprising phosphorus and the precipitation composition is about 2 ppm to about 40 ppm, and such that a concentration of calcium in the combination of the water comprising phosphorus and the precipitation composition is about 30 ppm to about 100 ppm;
raising the pH of the mixture of the water comprising the phosphorus and the precipitation composition to about 9.5 to about 11.6
forming a precipitate in mixture of the water comprising the phosphorus and the precipitation composition, the precipitate comprising a magnesium phosphate salt that comprises
the phosphorus, and
magnesium, calcium, or a combination thereof;
removing the precipitate comprising the phosphorus from the water comprising the precipitate, to form water having precipitate removed therefrom having a lower dissolved phosphorus concentration than the water comprising the phosphorus that was combined with the precipitation composition; and
neutralizing the water having precipitate removed therefrom.

19. A method of removing phosphorus from water, the method comprising:
raising the pH of water comprising phosphorus to about 9.5 to about 11.6, wherein the water comprises magnesium and calcium;
forming a precipitate in mixture of the water comprising the phosphorus and the precipitation composition, the precipitate comprising a phosphate salt that comprises
the phosphorus, and
magnesium, calcium, or a combination thereof;
removing the precipitate comprising the phosphorus from the water comprising the precipitate, to form water having precipitate removed therefrom having a lower dissolved phosphorus concentration than the water comprising the phosphorus in an oxidized form; and
neutralizing the water having precipitate removed therefrom.

20. An apparatus for performing the method of claim 1, the apparatus comprising:
an optional reactor for contacting an oxidizer and water comprising phosphorus to form water comprising phosphorus in an oxidized form;
a precipitation apparatus for combining the water comprising phosphorus with a precipitation composition comprising a magnesium salt, a calcium salt, or a combination thereof, to form a precipitate at a pH of about 9.5 to about 11.6, the precipitate comprising
the phosphorus, and
calcium, magnesium, or a combination thereof;
a filtration apparatus for removing the precipitate from the water comprising the precipitate, to form a filtrate having a lower dissolved phosphorus concentration than the water comprising phosphorus that was combined with the precipitation composition.
